(19) United States
(12) Patent Application Publication
(10) Pub. No.: US 2015/0349368 A1
(43) Pub. Date: Dec. 3, 2015

(54) REVERSIBLE ALKALINE MEMBRANE HYDROGEN FUEL CELL-WATER ELECTROLYZER

(71) Applicants: Christopher G. ARGES, Chicago, IL (US); Javier PARRONDO, Chicago, IL (US); Vijay K. RAMANI, Chicago, IL (US)

(72) Inventors: Christopher G. ARGES, Chicago, IL (US); Javier PARRONDO, Chicago, IL (US); Vijay K. RAMANI, Chicago, IL (US)

(21) Appl. No.: 14/289,789

(22) Filed: May 29, 2014

(51) Int. Cl. H01M 8/18; H01M 8/10; C25B 1/10; H01M 8/06; C25B 9/10

(52) U.S. Cl. CPC H01M 8/186; H01M 8/0656; C25B 9/10; C25B 1/10; H01M 8/1004; H01M 8/1067; H01M 2008/1095; H01M 2250/20; H01M 2300/0082

(57) ABSTRACT

Devices, systems, methods and/or processes based on or employing a reversible anion exchange polymer electrolyte membrane (AEM). A unitized membrane electrode assembly includes an anion exchange polymer electrolyte membrane disposed between a hydrogen electrode and an oxygen electrode. These electrodes each contain an anion exchange polymer electrolyte binder. The unitized membrane electrode assembly is effective in an alkaline environment for fuel cell operation and water electrolyzer operation.

### BACKGROUND OF THE INVENTION

1. Field of the Invention

This invention relates generally to fuel cells and, more particularly, to reversible membrane-containing fuel cell-water electrolyzers such as may he used to generate either or both electric power and hydrogen fuel.

2. Description of Related Art

The market for electric vehicles (EVs) has gained significant momentum in recent years due to threats and concerns relating to factors such as global warming and the obtaining of fossil fuel such as through drilling, mining or importation. Current trends in the automotive market and governmental regulatory policies have and likely will continue to favor growth in the use of EVs. EV technology, however, faces significant limitations that act to restrain the further penetration of EV technology into the mainstream. Currently, two primary technology platforms exist for electric vehicles and they include battery electric vehicles (BEVs) and fuel cell electric vehicles (FCEVs). The main limitations with BEVs include their limited range and limited vehicle size. These limitations arise from the fact that these batteries are not modular and become increasingly heavy when a large energy demand is needed. In other words, today's large BEVs (such as pick-up trucks, vans, or SUVs, for example) do not have a 300-mile range on a single-charge. Additionally, present day BEVs generally suffer from slow charge rates and customers are typically required to own a garage to charge their cars overnight. As a result, consumers are typically hesitant or reluctant to purchase a BEV as BEVs make going on long road trips—a feature most customers expect when making an expensive investment in a vehicle—more troublesome than desired.

FCEVs, on the other hand, have witnessed tremendous progress over the past 15 years where the cost of the fuel cell stack, performance, and durability can meet requirements for almost any type of vehicle. A major obstacle to FCEVs breaking into the market has been the absence of hydrogen refueling stations. BEVs have had the upper hand over FCEVs in recent years because there are sizeable populations who own homes where they can charge their vehicles overnight.

In view of the above, there is a need and a demand for systems and methods which would permit a FCEV to be refueled at home and eliminate an immediate need for hydrogen refueling stations—a costly and long-term infrastructure project. The capability to refuel at home and the elimination of the need for hydrogen refueling stations would constitute a major market transformation, because larger EVs, like trucks, vans, SUVs, would be possible and they could easily go 300 miles or more prior to requiring refueling.

Current proton exchange membrane technology operates in an acid environment and utilize a proton exchange membrane (PEM). PEM fuel cells typically employ platinum electrodes while PEM electrolyzers use iridium oxide for oxygen evolution and platinum for hydrogen evolution. In PEM designs, typically there are no good choices for a bi-functional oxygen reduction and evolution catalyst. Therefore, reversible PEM fuel cell and water electrolyzers in a single-unitized device are hard to realize. Additionally, operation in an acidic environment generally necessitates the use of platinum group electrocatalyst in the electrode layers. As will be appreciated, commercialized systems employing platinum group metal catalysts can be more costly than desired.

Present day reversible solid oxide fuel cells typically employ ceramic electrolytes and operate at temperatures above 500° C. As a result, the use of such reversible solid oxide fuel cells has been generally limited to stationary applications.

Reversible fuel cell concepts have been discussed in various recent patent documents including: EP2424015 A1, US 2002/0172844 A1, US2005/0048334 A1, US 2003/0068544 A1, and WO 2007/091050 A1, for example. These documents include discussions of proton exchange membrane (PEM) reversible fuel cells or solid oxide reversible fuel cells as well as a partitioned reversible fuel cell (non-unitized cell) for both a PEM and AEM device.

### SUMMARY OF THE INVENTION

As detailed further below, the invention provides new assemblies, systems and methods whereby the possibility of replenishing a hydrogen fuel source at home such as by simply plugging the device into a wall electrical outlet can be realized.

The reversible alkaline membrane hydrogen fuel-water electrolyzer fuel cell system technology disclosed herein advantageously does not use conventional acidic polymer electrolytes, but rather uses an alkaline-based polymer electrolyte. In conventional proton exchange membrane (PEM) fuel cells and water electrolyzers that operate in acidic media, different electrocatalysts are needed for oxygen reduction and oxygen evolution. However, the use of an alkaline media allows the use a single bi-functional electrocatalyst for oxygen reduction and evolution. Additionally, an alkaline environment mitigates the need for platinum group metals, which drastically reduces the costs when compared to conventional acidic fuel cells.

Moreover, the technology disclosed herein advantageously employs an anion exchange polymer electrolyte membrane, also sometime referred to as a hydroxide ion exchange membrane or an alkaline membrane. As described in greater detail below, the alkaline environment enables the use of platinum or non-platinum group metals for the necessary redox reactions (i.e., hydrogen oxidation/evolution and oxygen reduction/evolution). Further, as the invention advantageously employs a polymer electrolyte system, it can achieve relatively high power density at temperatures below 100° C., making the invention amenable to portable or stationary applications.

In accordance with one aspect of the subject development, there is provided a unitized membrane electrode assembly. In one embodiment, such a unitized membrane electrode assembly includes an anion exchange polymer electrolyte membrane disposed between a hydrogen electrode and an oxygen electrode. The hydrogen electrode and the oxygen electrode each contain an anion exchange polymer electrolyte binder and the unitized membrane electrode assembly is effective in an alkaline environment for fuel cell operation and water electrolyzer operation.

Another aspect of the subject development relates to a cell of a unitized reversible anion exchange polymer membrane fuel cell-water electrolyzer. In accordance with one embodiment, such a cell includes a unitized membrane electrode assembly that includes an anion exchange polymer electrolyte membrane disposed between a hydrogen electrode and an oxygen electrode. The hydrogen electrode and the oxygen electrode each contain an anion exchange polymer electrolyte binder and the unitized membrane electrode assembly is effective in an alkaline environment for fuel cell operation and water electrolyzer operation. The Cell further includes a first backing layer disposed adjacent the hydrogen electrode opposite the anion exchange polymer electrolyte membrane A first flow-field for reactant and/or product transport is disposed adjacent the first backing layer opposite the hydrogen electrode. A first current collector is disposed adjacent the first flow-field opposite the first backing layer. A second backing layer is disposed adjacent the oxygen electrode opposite the anion exchange polymer electrolyte membrane. A second flow-field for reactant and/or product transport is disposed adjacent the second backing layer opposite the oxygen electrode. A second current collector is disposed adjacent the second flow-field opposite the second backing layer. An electrical load/source is operatively connected to the hydrogen and oxygen electrodes. In fuel cell mode, the unitized reversible anion exchange polymer membrane fuel cell-water electrolyzer supplies electrical power when fed hydrogen and oxygen-containing gas. In water electrolyzer mode, the unitized reversible anion exchange polymer membrane fuel cell-water electrolyzer electrolyzes water to form H₂.

Still another aspect of the subject development relates to a reversible anion exchange polymer membrane fuel cell-water electrolyzer system. In one embodiment, such as system includes a reversible anion exchange polymer membrane fuel cell-water electrolyzer stack including a plurality of cells such as described above. The system further includes a hydrogen supply/storage container and a water supply/storage container each connected to the reversible anion exchange polymer membrane fuel cell-water electrolyzer stack. During fuel cell mode operation, oxygen-containing gas and hydrogen are supplied to the unitized reversible anion exchange polymer membrane fuel cell-water electrolyzer to produce electrical power and water, with the water conveyed to the water supply/storage container. During water electrolyzer mode operation, water and electric power are supplied to the reversible anion exchange polymer membrane fuel cell-water electrolyzer stack to generate hydrogen and the hydrogen is conveyed to the hydrogen supply/storage container.

In another aspect, there is provided a method of producing electric power and generating hydrogen. In accordance with one embodiment, such a method involves:

supplying oxygen-containing gas and hydrogen to a unitized reversible anion exchange polymer membrane fuel cell-water electrolyzer to produce electrical power and water and

supplying water and electric power to a unitized reversible anion exchange polymer membrane fuel cell-water electrolyzer to produce hydrogen.

In yet another aspect, there is provided a method of operating a reversible anion exchange polymer membrane fuel cell-water electrolyzer that includes at least one cell having an anion exchange polymer electrolyte membrane disposed between a hydrogen electrode and an oxygen electrode, with an electrical load/source operatively connected to the hydrogen and oxygen electrodes. In accordance with one embodiment, such a method involves:

a fuel cell mode operation wherein oxygen-containing gas and hydrogen are supplied to the unitized reversible anion exchange polymer membrane fuel cell-water electrolyzer to produce electrical power and water and

a water electrolyzer mode operation wherein water and electric power are supplied to the reversible anion exchange polymer membrane fuel cell-water electrolyzer to generate hydrogen.

While reference is made herein to “anion exchange polymer electrolyte membranes” (AEMs), such membranes, can where appropriate, be known by various alternative names including: anion exchange membranes, hydroxide exchange membranes, hydroxide ion exchange membranes, hydroxide polymer electrolyte exchange membrane, hydroxide polymer electrolyte ion exchange membrane, alkaline membrane and alkaline polymer electrolyte membrane, for example.

### BRIEF DESCRIPTION OF THE DRAWINGS

Objects and features of this invention will be better understood from the following description taken in conjunction with the drawings, wherein:

FIG. 1 is a simplified schematic of a unitized membrane electrode assembly for a reversible alkaline membrane fuel cell-water electrolyzer in accordance with one embodiment of the invention;

FIG. 2 is a simplified schematic representation of a cell in a unitized reversible alkaline membrane fuel cell-water electrolyzer in accordance with one embodiment of the invention;

FIG. 3 is a simplified flow diagram depicting a reversible alkaline membrane fuel cell-water electrolyzer system in accordance with one embodiment of the invention; and

FIG. 4 is a graphical representation of cell voltage versus current density in electrolyzer and fuel cell modes, respectively, thus providing a proof-of-concept demonstration of a unitized reversible alkaline membrane fuel cell-water electrolyzer in accordance with the invention.

### DESCRIPTION OF PREFERRED EMBODIMENTS

The invention provides new devices, systems, methods and/or processes based on or employing reversible anion exchange polymer electrolyte membrane (AEM) hydrogen fuel cell-water electrolyzers such as herein described. That is, in addition to reversible anion exchange polymer electrolyte membrane hydrogen fuel cell-water elcctrolyzer devices and systems the invention in its broader terms also provides new processing for the generation of electrical power and/or hydrogen fuel. In one preferred embodiment there is provided a device such as having the form of a single-unitized cell or stack that is capable of providing electrical power when hydrogen fuel and an oxygen-containing gas (such as O₂, air, or oxygen-enriched air, for example) is supplied or can serve as a water electrolyzer such as to use water to produce hydrogen when an external electrical power source is supplied. Cells in a device in accordance with one embodiment of the invention preferably include an anion exchange polymer electrolyte membrane capable of conducting hydroxide ions disposed between respective hydrogen and oxygen electrodes. The hydrogen electrode preferably comprises a bi-functional electrocatalyst or a mixture of electrocatalysts for performing hydrogen oxidation and/or evolution in alkaline media. The oxygen electrode preferably comprises a bi-functional electrocatalyst or a mixture of electrocatalysts for oxygen reduction and/or evolution in alkaline media.

The invention differs significantly from current state-of-the-art proton exchange membrane technology because the invention desirably does not operate in an acid environment nor does it utilize a proton exchange membrane. The invention also differs from reversible solid oxide fuel cells such as use ceramic electrolytes and operate above 500° C. which limit their utility to stationary applications. As described in greater detail below, the invention desirably employs a hydroxide ion exchange membrane (i.e., an anion exchange polymer electrolyte membrane). The employment and use of such an alkaline environment enables the use of platinum or non-platinum group metals for the necessary redox reactions (i.e., hydrogen oxidation/evolution and oxygen reduction/evolution). As the invention is a polymer electrolyte system, the invention can achieve relatively high power densities at temperatures below 100° C., making the invention amenable to portable and/or stationary applications.

Furthermore, the invention has the advantage that the alkaline environment facilitates the use of a single, bi-functional electrocatalyst for oxygen reduction and evolution allowing for a single-unitized device capable of running in fuel cell mode or water electrolyzer mode. PEM fuel cells typically use platinum electrodes while PEM electrolyzers typically use iridium oxide for oxygen evolution and platinum for hydrogen evolution. In such PEM designs, there are generally no good choices for a bi-functional oxygen reduction and evolution catalyst. Therefore, a reversible PEM fuel cell and water electrolyzer in a single-unitized device has been hard to realize. Additionally, the operation of a device in accordance with the invention in an alkaline environment rather than an acidic environment enables the use of non-platinum group electrocatalyst in the electrode layers. This has the benefit of lower cost when compared to commercialized systems employing platinum group metal catalysts.

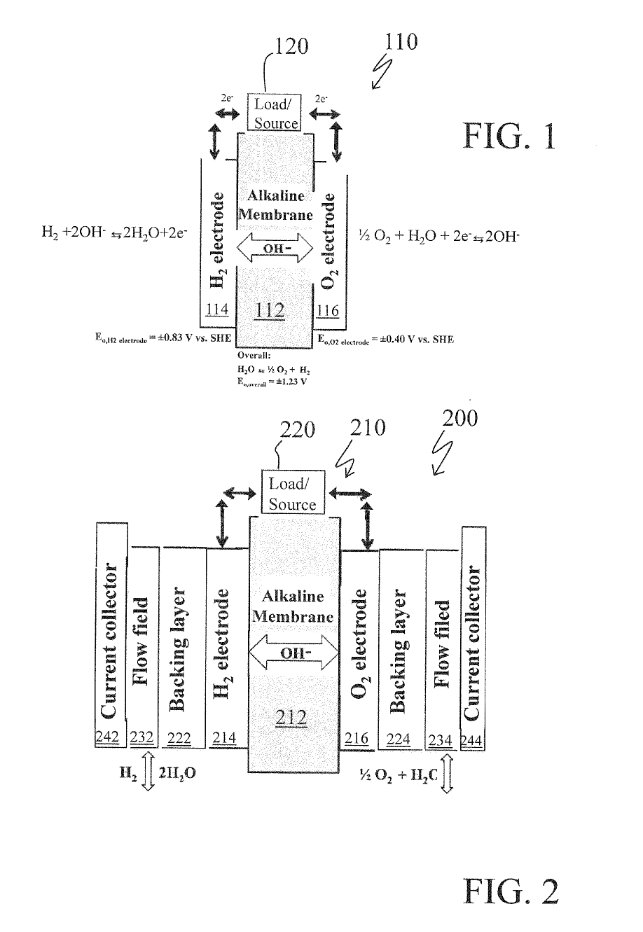

FIG. 1 is a simplified schematic of a unitized membrane electrode assembly (MEA), generally designated by the reference numeral 110, for a reversible anion exchange polymer electrolyte membrane fuel cell-water electrolyzer in accordance with one embodiment of the invention. As shown, the unitized membrane electrode assembly 110 includes an anion exchange polymer electrolyte membrane 112 disposed between an H₂ electrode 114 and an O₂ electrode 116 and is operatively connected to a load/source 120. FIG. 1 shows and includes half-cell reactions and standard potentials versus a standard hydrogen electrode (SHE).

FIG. 2 is a simplified schematic representation of a cell, generally designated by the reference numeral 200, of a unitized reversible alkaline or anion exchange polymer electrolyte membrane fuel cell-water electrolyzer in accordance with one embodiment of the invention. Each cell 200 in such a unitized reversible anion exchange polymer electrolyte membrane fuel cell-water electrolyzer contains a membrane electrode assembly 210, such as described above with reference to FIG. 1, and includes an anion exchange polymer electrolyte membrane 212 disposed between an H₂ electrode 214 and an O₂ electrode 216 and is operatively connected to a load/source 220. The cell 200 also includes backing layers 222 and 224, respectively, for water and gas diffusion, flow fields 232 and 234, respectively, for the delivery of water and gas species, and current collectors 242 and 244, respectively.

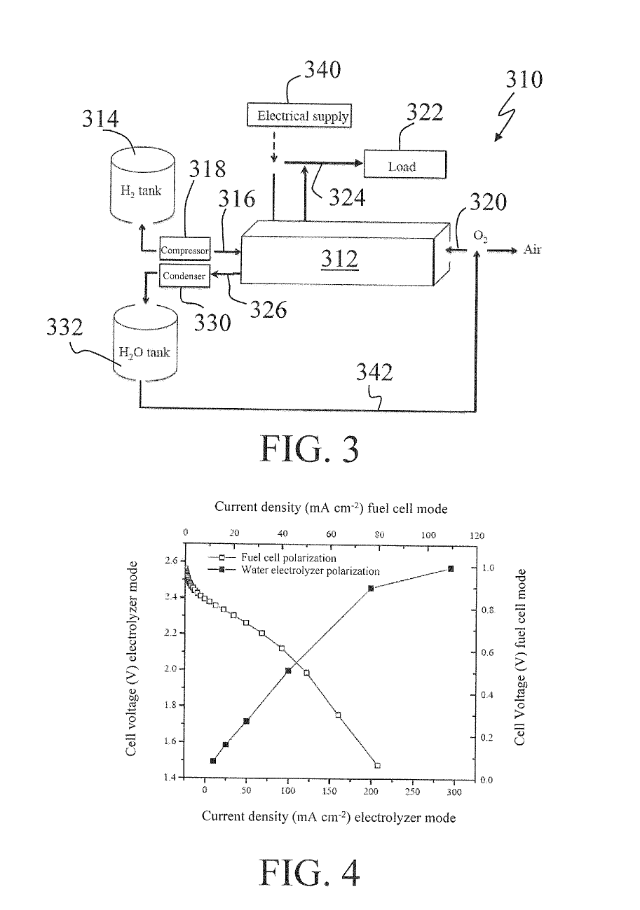

FIG. 3 is a simplified flow diagram depicting a reversible anion exchange polymer electrolyte membrane fuel cell-water electrolyzer system, generally designated by the reference numeral 310, in accordance with one embodiment of the invention. The reversible anion exchange polymer electrolyte membrane fuel cell-water electrolyzer system 310 includes a reversible anion exchange polymer electrolyte membrane fuel cell-water electrolyzer stack 312 such as generally composed of cells such as described above with reference to FIG. 2.

In fuel cell mode, hydrogen (H₂) from a H₂ tank 314, such as via a line 316, and an oxygen-containing gas (such as O₂, air or oxygen-enriched air, for example), such via a line 320, are introduced or flow into the reversible anion exchange polymer electrolyte membrane fuel cell-water electrolyzer stack 312 to produce electrical power that is supplied to the load 322 via a line 324. By-product water (H₂O) from fuel cell operation exits the stack 312 via a line 326, is condensed via a condenser 330, and is collected in an H₂O tank 332.

In water electrolyzer mode, the reversible anion exchange polymer electrolyte membrane fuel cell-water electrolyzer stack 312 is supplied with electrical power from an electrical supply 340 (such as by being plugged into an electric wall outlet or supplied from a solar cell, for example). Water is fed into the reversible anion exchange polymer electrolyte membrane fuel cell-water electrolyzer stack 312 from the H₂O tank 332 via a line 342 and electrolyzed to form hydrogen gas. The hydrogen gas can be compressed via the compressor 318 and introduced and collected in the H₂ tank 314 via the line 316. Oxygen gas produced from the water electrolyzer can be released or discarded such as into the air, as appropriate or desired.

FIG. 4 is a graphical representation of cell voltage versus current density in electrolyzer and fuel cell modes, respectively, thus providing a proof-of-concept demonstration of a unitized reversible anion exchange polymer electrolyte membrane fuel cell-water electrolyzer in accordance with the invention. The single unitized cell test employed in this case included a platinum hydrogen electrode, a lead ruthenate pyrochlore oxygen electrode and a polysulfone quaternary benzyl trimethylammonium hydroxide membrane.

TABLE 1, below, identifies different hydrogen electrode, oxygen electrode, anion exchange polymer electrolyte (e.g., alkaline polymer electrolyte) membrane and backing layer materials, respectively, useable in reversible alkaline membrane hydrogen fuel-water electrolyzers in accordance with selected embodiments of the invention.

TABLE 1

| Hydrogen | Oxygen | Anion exchange polymer electrolyte | |
|---|---|---|---|
| electrode | electrode | membrane | Backing layers |
| Platinum group | Platinum | Homopolymers | Backing layer: |
| metals: | group metals: | Many different forms of homopolymer | Titanium or |
| Platinum | Platinum | alkaline membranes can be used. | titanium alloy |
| Platinum- | Lead | Polymer backbone types may include: | plates |
| nickel | ruthenate | Polyaromatics: poly(aryl ether)s- | Nickel foam |
| hydroxyl with | pyrochlore | poly(aryl ether) sulfones or | Stainless steel |
| Iithium cations | Iridium | ketones, or poly (fluorene ether)s, | fiber felt |
| Iridium-with | oxide | poly(2,6-dimethyl 1,4-phenylene) | |
| oxophilic sites | | oxide, or poly(phenylenes) | |
| (i.e., defects) | | Polyaliphatic: polyethylene, | |
| Platinum- | | polystyrene type co-polymers (e.g., | |
| ruthenium | | polystyrene-polyacrylonitrile co- | |
| | | polymers) | |
| | | Perfluorinated or partially | |
| | | fluorinated polymers (e.g., FEP, | |
| | | PTFE, or ETFE) | |
| | | Others | |
| | | Affixed cation groups to the above | |
| | | polymer backbones can include: | |
| | | Quaternary ammonium types | |
| | | Quaternary phosphonium types | |
| | | Ternary sulfonium types, | |
| | | Ternary sulfoxonium types | |
| | | Quaternary arsonium types, | |
| | | Imidazolium types | |
| | | Guanidium types | |
| | | Phosphazenium types (i.e., | |
| | | alkylamio phosphonium) | |
| | | Metal-based cations of ruthenium | |
| | | pyridine or cobaltcenium | |
| | | Tethering strategies for the cation to | |
| | | polymer backbone | |
| | | Cation to the benzyl position of the | |
| | | polymer backbone | |
| | | An n-alkyl pendant chain to the | |
| | | polymer backbone with a terminal | |
| | | cation group | |
| | | Amin-alkyl linkers | |
| Non-platinum | Non-platinum | Heterogeneous polymer membranes | |
| group metals: | group metals: | Many type of membrane materials | |
| Nickel | Silver | where an anion exchanger or | |
| Nickel- | Silver-gold | hydroxide ion exchanger is | |
| chromium | Copper | imbedded into an inert matrix | |
| Nickel-cobalt- | cobalt | May include ion-solvating | |
| molybdenum | oxide | polymers like: | |
| Cobalt oxide- | Cobalt- | polyethylene oxide (PEO) | |
| nickel | polypyrrole | (mixed with metal hydroxide | |
| Nickel- | Nickel | salts like NaOH, LiOH, or | |
| molybdenum | cobalt | KOH), polyvinyl alcohol | |
| Nickel with | oxide | (PVA) mixed with quaternary | |
| cerium oxide- | Nickel-iron | ammonium hydroxide salts, | |
| lanthanum | Cobalt | PEO-PVA copolymers with | |
| oxide | based | metal hydroxide or quaternary | |
| Nickel- | catalysts | ammonium salts, chitosan | |
| tungsten | | doped with metal hydroxide | |
| | | salts, polybenzimidazole | |
| | | mixed with metal hydroxide | |
| | | salts | |
| | | May include hybrid membranes | |
| | | like: | |
| | | Organic-inorganic membranes- | |
| | | functionalized silica with | |
| | | quaternary ammonium groups, | |
| | | silica, or zirconia, titania | |
| | | imbedded into a homopolymer | |
| | | (see above) with or without | |
| | | metal hydroxide salts | |
| | | Interpenetrating polymer | |
| | | network where a polycation | |
| | | polymer is impregnated into | |
| | | porous substrate (e.g., | |
| | | polyvinylpyridinium hydroxide | |
| | | into porous PTFE or | |
| | | polyethylene membranes) | |

In accordance with a preferred embodiment, the hydrogen electrode and the oxygen electrode in addition to a bi-functional electrocatalyst or a mixture of electrocatalysts for performing hydrogen oxidation and/or evolution in alkaline media, such as described above, additionally contains or includes a binder, such as preferably of the same anion exchange polymer electrolyte as present in or constituting the anion exchange polymer electrolyte membrane. For example, in assemblies, cells or systems, in accordance with certain preferred embodiments and wherein the anion exchange polymer electrolyte membrane comprises, includes or is composed of poly(2,6-dimethyl 1,4-phenylene oxide), the hydrogen electrode and the oxygen electrode, in addition to a bi-functional electrocatalyst or a mixture of electrocatalysts for performing hydrogen oxidation and/or evolution in alkaline media, preferably additionally contains or includes a binder that comprises, includes or is composed of poly(2,6-dimethyl 1,4-phenylene oxide).

Those skilled in the art and guided by the teachings herein provided will understand and appreciate that such inclusion of the anion exchange polymer electrolyte binder in the electrode layer can beneficially serve one or more various functions including, but not necessarily limited to: a.) binding or keeping the electrode materials together, b.) placing the electrode layer in intimate contact with the anion exchange polymer electrolyte membrane and c.) helping to conduct the hydroxide ions from the anion exchange polymer electrolyte membrane to the surface of the electrocatalyst in the electrode layer.

As will be appreciated by those skilled in the art and guided by the teachings herein provided, assemblies, cells or systems, in accordance with invention can comprise various combinations of hydrogen electrode, oxygen electrode, anion exchange polymer electrolyte (e.g., alkaline polymer electrolyte) membrane and backing layer materials, such as including those materials set forth in TABLE 1.

By way of example, one preferred embodiment of a reversible alkaline membrane fuel cell in accordance with the invention includes platinum group metals such as an oxygen electrode including a mixture of platinum black nanoparticles and lead ruthenate pyrochlore, a hydrogen electrode including iridium-oxide or platinum-ruthenium alloys, a membrane such as a quaternary ammonium-type AEM membrane such as from Tokuyama Co., such as known as Tokuyama A201 or Tokuyama AHA membrane or a poly(2,6-dimethyl 1,4-phenylene oxide) AEM, with the binder derived from poly(2,6-dimethyl 1,4-phenylene oxide) AEM, and a backing layer such as or in the form of a porous titanium sheet or stainless steel sheet mesh, for example.

A preferred embodiment of a reversible alkaline membrane fuel cell in accordance with the invention that includes non-platinum group metals includes an oxygen electrode including a mixture of silver and gold or silver, a hydrogen electrode comprising a mixture of nickel-cobalt-molybdenum, a membrane such as a quaternary ammonium-type AEM membrane such as from Tokuyama Co., such as known as Tokuyama A201 or Tokuyama AHA membrane or a poly(2,6-dimethyl 1,4-phenylene oxide) AEM, with the binder derived from poly(2,6-dimethyl 1,4-phenylene oxide) AEM, and a backing layer such as or in the form of a porous titanium sheet or stainless steel sheet mesh, for example.

Those skilled in the art and guided by the teachings herein provided will understand and appreciate that the practice of the invention is not generally limited by the size or dimensions of components employed in a particular or specific assembly, cell or system of the invention. In accordance with certain preferred embodiments, the invention can desirably be practiced employing:
1, membrane thicknesses in a range of from 10 microns to 200 microns;
2. electrode thicknesses in a range of from 0.5 microns to 15 microns; and
3. backing layer thicknesses in a range of from 80 microns to 2 mm.
   Moreover, the surface area (e.g., length×width) of membrane electrode assemblies with backing layer for each cell can also be correspondingly also appropriately varied. For example, membrane electrode assemblies as large as 2 meters×1 meter might be used for stationary fuel cells. In certain tested embodiments, single cells with surfaces areas in a range of 2 to 5 cm² have been employed. In accordance with particular embodiments of the invention, the surface area (e.g., length×width) of membrane electrode assemblies in accordance with the invention can be: less than 100 cm²; about 100 cm²; and/or greater than 100 cm², as may be desired for use in particular applications.

Those skilled in the art and guided by the teachings herein provided will appreciate that the invention, such as through the reversible anion exchange polymer electrolyte membrane hydrogen fuel cell-water electrolyzer disclosed herein, allows for and permits replenishment of an at-home hydrogen fuel source such as by simply appropriately connecting such a device or system in accordance with the invention, such as by plugging such device or system into an electrical wall outlet.

The technology of the invention is made possible at least in part because the subject fuel systems desirably use or employ an alkaline-based polymer electrolyte, rather than conventional acidic polymer electrolytes, for example.

Furthermore, whereas in conventional proton exchange membrane (PEM) fuel cells and water electrolyzers that operate in acidic media, different electrocatalysts are needed for oxygen reduction and oxygen evolution, the use in the invention of an alkaline media allows the use a single bi-functional electrocatalyst for oxygen reduction and evolution. The alkaline environment also advantageously mitigates the need for platinum group metals, which drastically reduces the costs when compared to conventional acidic fuel cells.

Market penetration is not necessarily precluded even if the invention simply matches the performance attainable with current state-of-the-art PEM electrolyzer and fuel cell devices. For example, the invention can permit or allow lower prices and/or costs, such as by circumventing the use of platinum group metals. That is, systems in accordance with certain preferred embodiments of the invention can be lower cost because those systems are not required to contain platinum group metals. Increased or improved device performance may also be realized through further research such as by optimizing the fabrication of the membrane electrode assembly and selection of better alkaline membrane and catalyst(s) materials.

Those skilled in the art and guided by the teachings herein provided will appreciate that the invention herein described has or can have many and varied immediate uses including in the electrified vehicle market that may include small and large automotive vehicles (motorcycles, bikes, cars, trucks, buses, forklifts, etc.). Additional likely or potential applications for uses include military and aerospace applications (unmanned aircrafts, unmanned underwater vehicles, portable power for soldiers, etc.), for example.

The invention also comprehends methods of producing electric power and generating hydrogen, such as by supplying an oxygen-containing gas and hydrogen to a unitized reversible anion exchange polymer membrane fuel cell-water electrolyzer, such as described above, such as to produce electrical power and water and/or supplying water and electric power to such a unitized reversible anion exchange polymer membrane fuel cell-water electrolyzer to produce hydrogen.

Still further, the invention comprehends methods of operating a reversible anion exchange polymer membrane fuel cell-water electrolyzer, such as described above, such as includes at least one cell having an anion exchange polymer electrolyte membrane disposed between a hydrogen electrode and an oxygen electrode, with an electrical load/source operatively connected to the hydrogen and oxygen electrodes. The method comprising:

a fuel cell mode operation wherein oxygen-containing gas and hydrogen are supplied to the unitized reversible anion exchange polymer membrane fuel cell-water electrolyzer to produce electrical power and water and

a water electrolyzer mode operation wherein water and electric power are supplied to the reversible anion exchange polymer membrane fuel cell-water electrolyzer to generate hydrogen.

In view of the above, the invention generally provides:
1. A unitized reversible alkaline membrane hydrogen fuel cell-water electrolyzer device, system or assembly wherein, during fuel cell mode operation, the device supplies electrical power when fed hydrogen fuel and an oxygen-containing gas (such as O₂, air, or oxygen-enriched air, for example). The water by-product from this reaction is captured. In water electrolyzer mode operation, water captured during fuel cell operation or fed externally is electrolyzed to form hydrogen fuel that is stored.
2. A device, system or assembly such as herein provided or described and comprising a hydroxide ion exchange (also known as an anion exchange) polymer electrolyte membrane that separates or is disposed between two electrodes.
3. A device, system or assembly such as herein provided or described and further including a hydrogen electrode comprising a hi-functional electrocatalyst or a mixture of electrocatalysts for hydrogen oxidation and hydrogen evolution redox reactions.
4. A device, system or assembly such as herein provided or described and further comprising an oxygen electrode comprising a bi-functional electrocatalyst or a mixture of electrocatalysts for oxygen reduction or oxygen evolution.
5. A device, system or assembly such as herein provided or described and further comprising a backing layer behind at least one and preferably behind each electrode, such backing layer preferably comprising an electrochemically stable, electron conducting, alkaline-resistant porous substrate that permits the flow of gases or liquid or gas water in and out of the cell. In selected preferred embodiments, such a porous substrate can be woven metal, perforated metal sheets, or a metal foam, for example.
6. A device, system or assemble such as herein provided or described and further comprising behind at least one and preferably behind each backing layer a flow-field for reactant and/or product transport (i.e., hydrogen, oxygen, and/or water) and that is electrically conductive and electrochemically stable. The flow fields may also be the bipolar plates for fuel cell and water electrolyzer operation.
7. A unitized stack or cell such as herein provided or described and connected to a hydrogen tank and a water tank. Hydrogen generated during electrolysis can be compressed and stored in the hydrogen tank. The hydrogen tank can be used to release hydrogen into the reversible alkaline membrane fuel cell-water electrolyzer to produce electrical power. Water produced from fuel cell operation can be collected and condensed in the water storage tank. Supplying an external electrical power source to the reversible alkaline membrane fuel cell-water electrolyzer and feeding water into the device will produce hydrogen fuel.

While the invention has been described above making specific reference to use or application in the field of electric vehicles, those skilled in the art and guided by the teachings herein provided will understand and appreciate that the invention herein described can find application and utility in many and varied applications and uses such as including, but not necessarily limited to: powering portable electronics and stationary applications (such as buildings, data centers, load leveling renewable energy sources like solar and wind, computer laptops and microgrid storage devices for electric utility companies, for example).

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A unitized membrane electrode assembly comprising an anion exchange polymer electrolyte membrane disposed between a hydrogen electrode and an oxygen electrode, wherein the hydrogen electrode and the oxygen electrode each contain an anion exchange polymer electrolyte binder and wherein the unitized membrane electrode assembly is effective in an alkaline environment for fuel cell operation and water electrolyzer operation.

2. The unitized membrane electrode assembly of claim 1 wherein the hydrogen electrode comprises a bi-functional electrocatalyst or a mixture of electrocatalysts for performing hydrogen oxidation and/or evolution in alkaline media.

3. The unitized membrane electrode assembly of claim 2 wherein the hydrogen electrode comprises at least one platinum group metal.

4. The unitized membrane electrode assembly of claim 3 wherein the hydrogen electrode comprises at least one material selected from the group consisting of platinum, platinum-nickel hydroxyl with lithium cations, iridium—with oxophilic sites, and platinum-ruthenium.

5. The unitized membrane electrode assembly of claim 4 wherein the hydrogen electrode comprises at least one non-platinum group metal.

6. The unitized membrane electrode assembly of claim 3 wherein the hydrogen electrode comprises at least one material selected from the group consisting of nickel, nickel-chromium, nickel-cobalt-molybdenum, cobalt oxide-nickel, nickel-molybdenum, nickel with cerium oxide-lanthanum oxide and nickel-tungsten.

7. The unitized membrane electrode assembly of claim 1 wherein the oxygen electrode comprises a bi-functional electrocatalyst or a mixture of electrocatalysts for oxygen reduction and/or evolution in alkaline media.

8. The unitized membrane electrode assembly of claim 7 wherein the oxygen electrode comprises at least one platinum group metal.

9. The unitized membrane electrode assembly of claim 8 wherein the oxygen electrode comprises at least one material selected from the group consisting of platinum, lead ruthenate pyrochlore and iridium oxide.

10. The unitized membrane electrode assembly of claim 7 wherein the oxygen electrode comprises at least one non-platinum group metal.

11. The unitized membrane electrode assembly of claim 10 wherein the oxygen electrode comprises at least one material selected from the group consisting of silver, silver-gold, copper cobalt oxide, cobalt-polypyrrole, nickel cobalt oxide, nickel-iron and cobalt based catalysts.

12. The unitized membrane electrode assembly of claim 1 wherein the anion exchange polymer electrolyte membrane is a homopolymer alkaline membrane having a polymer backbone type selected from the group consisting of polyaromatic, polyaliphatic and perfluorinated or partially fluorinated polymers.

13. The unitized membrane electrode assembly of claim 12 wherein affixed to the polymer backbone is at least one cation group selected from the group consisting of quaternary ammonium type, quaternary phosphonium type, ternary sulfonium type, ternary sulfoxonium type, quaternary arsonium type, imidazolium type, guanidium type, phosphazenium type, and metal-based cations of ruthenium pyridine or cobalteenium.

14. The unitized membrane electrode assembly of claim 1 wherein the anion exchange polymer electrolyte membrane is a heterogeneous polymer membrane comprising an anion exchanger or hydroxide ion exchanger imbedded in an inert matrix.

15. The unitized membrane electrode assembly of claim 1 wherein the anion exchange polymer electrolyte membrane comprises an anion exchange polymer material and the anion exchange polymer electrolyte binder also comprises said anion exchange polymer material.

16. A cell of a unitized reversible anion exchange polymer membrane fuel cell-water electrolyzer comprising the unitized membrane electrode assembly of claim 1 and further comprising:
a first backing layer disposed adjacent the hydrogen electrode opposite the anion exchange polymer electrolyte membrane,
a first flow-field for reactant and/or product transport disposed adjacent the first backing layer opposite the hydrogen electrode,
a first current collector disposed adjacent the first flow-field opposite the first backing layer,
a second backing layer disposed adjacent the oxygen electrode opposite the anion exchange polymer electrolyte membrane,
a second flow-field for reactant and/or product transport disposed adjacent the second backing layer opposite the oxygen electrode,
a second current collector disposed adjacent the second flow-field opposite the second backing layer, and
an electrical load/source operatively connected to the hydrogen and oxygen electrodes and
wherein,
in fuel cell mode, the unitized reversible anion exchange polymer membrane fuel cell-water electrolyzer supplies electrical power when fed hydrogen and oxygen-containing gas, and
in water electrolyzer mode, the unitized reversible anion exchange polymer membrane fuel cell-water electrolyzer electrolyzes water to form H₂.

17. The cell of claim 16 wherein at least one of the first and second backing layers comprises an electrochemically stable, electron-conducting, alkaline-resistant porous substrate that permits the flow of gases or liquid or gas water in and out of the cell.

18. The cell of claim 17 wherein the porous substrate is selected from the group consisting of woven metal, perforated metal, and metal foam.

19. The cell of claim 16 wherein at least one of the first flow-field and the second flow-field comprises a bipolar plate for fuel cell and water electrolyzer operation.

20. A reversible anion exchange polymer membrane fuel cell-water electrolyzer system comprising:
a reversible anion exchange polymer membrane fuel cell-water electrolyzer stack comprising a plurality of the cells of claim 16;
a hydrogen supply/storage container and a water supply/storage container each connected to the reversible anion exchange polymer membrane fuel cell-water electrolyzer stack;
wherein,
during fuel cell mode operation, oxygen-containing gas and hydrogen are supplied to the unitized reversible anion exchange polymer membrane fuel cell-water electrolyzer to produce electrical power and water, with the water conveyed to the water supply/storage container, and
during water electrolyzer mode operation, water and electric power are supplied to the reversible anion exchange polymer membrane fuel cell-water electrolyzer stack to generate hydrogen and the hydrogen is conveyed to the hydrogen supply/storage container.

21. The reversible anion exchange polymer membrane fuel cell-water electrolyzer system of claim 20 wherein, during fuel cell mode operation, hydrogen supplied to the unitized reversible anion exchange polymer membrane fuel cell-water electrolyzer comprises hydrogen conveyed to the unitized reversible anion exchange polymer membrane fuel cell-water electrolyzer from the hydrogen supply/storage container.

22. The reversible anion exchange polymer membrane fuel cell-water electrolyzer system of claim 21 wherein, during water electrolyzer mode operation, water supplied to the unitized reversible anion exchange polymer membrane fuel cell-water electrolyzer comprises water conveyed to the unitized reversible anion exchange polymer membrane fuel cell-water electrolyzer from the water supply/storage container.

23. The reversible anion exchange polymer membrane fuel cell-water electrolyzer system of claim 20 wherein, during water electrolyzer mode operation, water supplied to the unitized reversible anion exchange polymer membrane fuel cell-water electrolyzer comprises water conveyed to the unitized reversible anion exchange polymer membrane fuel cell-water electrolyzer from the water supply/storage container.

24. A method of alternatively producing electric power and generating hydrogen, the method comprising:
supplying oxygen-containing gas and hydrogen to a unitized reversible anion exchange polymer membrane fuel cell-water electrolyzer to produce electrical power and water and
supplying water and electric power to the unitized reversible anion exchange polymer membrane fuel cell-water electrolyzer to produce hydrogen.

25. The method of claim 24 wherein the unitized reversible anion exchange polymer membrane fuel cell-water electrolyzer comprises membrane electrode assembly including an anion exchange polymer electrolyte membrane disposed between a hydrogen electrode and an oxygen electrode, wherein the hydrogen electrode and the oxygen electrode each contain an anion exchange polymer electrolyte binder and wherein the unitized membrane electrode assembly is effective in an alkaline environment for fuel cell operation and water electrolyzer operation.

26. The method of claim 25 wherein:
the hydrogen electrode comprises a bi-functional electrocatalyst or a mixture of electrocatalysts for performing hydrogen oxidation and/or evolution in alkaline media;
the oxygen electrode comprises a bi-functional electrocatalyst or a mixture of electrocatalysts for oxygen reduction and/or evolution in alkaline media; and
at least one of the hydrogen electrode and the oxygen electrode comprises at least one non-platinum group metal.

27. The method of claim 25 wherein the anion exchange polymer electrolyte membrane is a homopolymer alkaline membrane having a polymer backbone type selected from the group consisting of polyaromatic, polyaliphatic and perfluorinated or partially fluorinated polymers.

28. The method of claim 25 wherein the anion exchange polymer electrolyte membrane is a heterogeneous polymer membrane comprising an anion exchanger or hydroxide ion exchanger imbedded in an inert matrix.

29. The method of claim 25 wherein the anion exchange polymer electrolyte membrane comprises an anion exchange polymer material and the anion exchange polymer electrolyte binder also comprises said anion exchange polymer material.

30. A method of operating a reversible anion exchange polymer membrane fuel cell-water electrolyzer that includes at least one cell having an anion exchange polymer electrolyte membrane disposed between a hydrogen electrode and an oxygen electrode, with an electrical load/source operatively connected to the hydrogen and oxygen electrodes, the method comprising:
a fuel cell mode operation wherein oxygen-containing gas and hydrogen are supplied to the unitized reversible anion exchange polymer membrane fuel cell-water electrolyzer to produce electrical power and water and
a water electrolyzer mode operation wherein water and electric power are supplied to the reversible anion exchange polymer membrane fuel cell-water electrolyzer to generate hydrogen.
